(19) United States
(12) Patent Application Publication
(10) Pub. No.: US 2025/0332569 A1
(43) Pub. Date: Oct. 30, 2025

(54) ATMOSPHERIC CARBON DIOXIDE SORBENT

(71) Applicant: Robert Bosch Gmbh, Stuttgart (DE)

(72) Inventor: Daniil A. KITCHAEV, Brookline, MA (US)

(21) Appl. No.: 18/650,229

(22) Filed: Apr. 30, 2024

(51) Int. Cl. B01J 20/26; B01D 53/62; B01D 53/81; B01J 20/28; B01J 20/30; B01J 20/32; C08F 12/08; C08F 26/02

(52) U.S. Cl. CPC B01J 20/267; B01D 53/62; B01D 53/81; B01J 20/28059; B01J 20/28061; B01J 20/28064; B01J 20/2808; B01J 20/28083; B01J 20/3085; B01J 20/3219; B01J 20/3282; C08F 12/08; C08F 26/02; B01D 2253/202; B01D 2253/306; B01D 2253/308; B01D 2257/504; B01D 2258/06; C08F 2810/20

(57) ABSTRACT

A sorbent for direct air capture of CO₂ includes a porous amine-functionalized polymeric material including a backbone and a plurality of side chains having amine groups branching from the backbone, the backbone including a rigid crosslinker having crosslinker groups, a ratio of the crosslinker groups to a total number of monomer repeating units in the polymeric material is about 0.1 to 0.4 such that the polymeric material's internal surface area is about 10 to 500 m²/g.

### TECHNICAL FIELD

The present disclosure relates to a sorbent for capture of atmospheric carbon dioxide (CO₂) and a method of making and using the same.

### BACKGROUND

Carbon dioxide is a notorious greenhouse gas whose emissions have been sharply on the rise since the Industrial Revolution began in the 18^{th} century. Since then, the CO₂ emissions have been a confirmed culprit in the climate change around the world. Recent findings of the International Panel on Climate Change have proposed that the CO₂ emissions should be halved by 2030 to avoid further negative impact on the planet. Various technologies have been developed to capture atmospheric CO₂, but their drawbacks prevent realization of more widespread CO₂ sequestration from air.

### SUMMARY

In one embodiment, a sorbent for direct air capture of CO₂ is disclosed. The sorbent may include a porous amine-functionalized polymeric material including a backbone and a plurality of side chains having amine groups branching from the backbone. The backbone may include a rigid crosslinker having crosslinker groups. A ratio of the crosslinker groups to a total number of monomer repeating units in the polymeric material may be about 0.1 to 0.4 such that the polymeric material's internal surface area is about 10 to 500 m²/g. An average micropore size of the sorbent may be about 5 to 20 Å. The crosslinker may retain an end-to-end distance of at least about 70% of its predetermined molecular geometry. The polymeric material may be polyallylamine. The polymeric material may be polystyrene. The crosslinker may include a conjugated benzene. The conjugated benzene may include anthracene. The crosslinker may include a polyphenyl compound directly bound to a side chain of the polymeric sorbent.

In another embodiment, a sorbent for direct air capture of CO₂ is disclosed. The sorbent may include a porous amine-functionalized polymeric material having an internal surface area of about 10 to 1500 m²/g at crosslinker fraction of about 20 to 60 mol %, based on a total molar number of monomers in the polymeric sorbent. The crosslinker may include at least two benzene rings. The crosslinker may be a rigid crosslinker which maintains an end-to-end distance of a least 70% of predetermined molecular geometry. An average micropore size of the sorbent may be about 5 to 20 A. The crosslinker may include a conjugated benzene compound. The crosslinker may include anthracene. The crosslinker may include a polyphenyl directly bound to a side chain of the polymeric sorbent.

In an alternative embodiment, a system for direct air capture of CO₂ is disclosed. The system may include a compartment housing a porous amine-functionalized polymeric sorbent including a rigid crosslinker configured to maintain a distance between amine groups of the sorbent. The crosslinker may be included in an amount of about 20 to 60 mol %, based on a total molar number of monomers in the polymeric sorbent, and have at least one benzene ring. The system may further include a first conduit structured to bring air into the compartment and a second conduit structured to lead CO₂-free air from the compartment. The crosslinker may be a rigid crosslinker which maintains an end-to-end distance of a least 70% of its predetermined molecular geometry. An average micropore size of the sorbent may be about 5 to 20 A. The crosslinker may include a conjugated benzene. The crosslinker may include a polyphenyl directly bound to a side chain of the polymeric sorbent. The crosslinker may include anthracene.

### BRIEF DESCRIPTION OF THE DRAWINGS

FIG. 1 is a schematic depiction of a non-limiting example direct-air-capture (DAC) system with CO₂ sorption into a solid sorbent and sorbent regeneration;

FIG. 2 shows a schematic depiction of an internal structure of a sorbent including macropores and micropores;

FIG. 3 is a plot of internal surface area of simulated crosslinked polymer resins based on amine-functionalized polystyrene (A) and polyallylamine (B) crosslinked with divinylbenzene;

FIGS. 4A and 4B show formulas of prior art crosslinkers;

FIGS. 5A to 5D show formulas of non-limiting example crosslinkers according to one or more embodiments disclosed herein;

FIGS. 6A to 6K show formulas of non-limiting example crosslinkers according to one or more embodiments disclosed herein;

FIG. 7A to 7C show a repeating monomer unit of Examples 1, 2, and Example A simulated resins;

FIG. 8A shows a plot of internal surface area of simulated crosslinked polyallylamine polymer resins crosslinked with Comparative Example A and Examples 1 and 2;

FIG. 8B shows a plot of average pore size of simulated crosslinked polyallylamine polymer resins crosslinked with Comparative Example A and Examples 1 and 2;

FIG. 9 shows water-free carbamate binding mechanism for CO₂ schematically illustrated for a non-limiting example amine-functionalized polystyrene sorbent;

FIG. 10 shows solvated carbamic acid binding mechanism for CO₂ schematically illustrated for a non-limiting example amine-functionalized polystyrene sorbent;

FIGS. 11A to 11C show non-limiting examples of tertiary amines incorporated into crosslinker molecules to provide additional binding sites for hydronium ions in the sorbent according to one or more embodiments disclosed herein; and

FIG. 12 shows the effect of tertiary and secondary amine incorporation into a crosslinker on internal surface area of the sorbent.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the disclosure. Practice within the numerical limits stated is generally preferred. Also, unless expressly stated to the contrary: percent, “parts of,” and ratio values are by weight; the description of a group or class of materials as suitable or preferred for a given purpose in connection with the disclosure implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed. Unless stated otherwise, the wt. % is based on the total weight of the substrate and the vol. % is based on the total volume of the substrate.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the disclosure can be obtained within a range of +/−5% of the indicated value. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . , 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. Similarly, whenever listing integers are provided herein, it should also be appreciated that the listing of integers explicitly includes ranges of any two integers within the listing.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

As used herein, the term “and/or” means that either all or only one of the elements of said group may be present. For example, “A and/or B” means “only A, or only B, or both A and B”. In the case of “only A,” the term also covers the possibility that B is absent, i.e. “only A, but not B”.

It is also to be understood that this disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The term “comprising” is synonymous with “including,” “having,” “containing,” or “characterized by.” These terms are inclusive and open-ended and do not exclude additional, unrecited elements or method steps. The term “including” or “includes” may encompass the phrases “comprise,” “consist of,” or “essentially consist of.”

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed subject matter can include the use of either of the other two terms.

The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. Also, the description of a group or class of materials as suitable for a given purpose in connection with one or more embodiments implies that the group or class of materials can “comprise,” “consist of,” and/or “consist essentially of” any member or the entirety of that group or class of materials. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Carbon dioxide or CO₂ is a primary greenhouse gas accounting for about 80% of all U.S. annual greenhouse gas emissions from human activities. The CO₂ emissions are a well-recognized global problem. Greenhouse gasses are gasses that trap heat in the atmosphere. The heat trapping causes changes in the radiative balance of the Earth that alter climate and weather patterns at global and regional scales. CO₂ is a chemical compound made up of molecules that each have one carbon atom covalently double bonded to two oxygen atoms. CO₂ is found in the gas state at ambient temperature. In the air, CO₂ is transparent to visible light but absorbs infrared radiation, thereby acting as a greenhouse gas. CO₂ enters the atmosphere through burning of fossil fuels such as coal, natural gas, and oil, solid waste, trees, and other biological materials. CO₂ further enters the atmosphere as a result of certain chemical reactions such as manufacturing of cement or aluminum. Additionally, when methane enters the atmosphere, it combines with oxygen to form CO₂.

Because of its negative impact on the global climate, efforts have been made to reduce CO₂ emissions, mostly by capture of CO₂ at the source of release such as from smokestacks of power plants, cement plants, or aluminum plants. Yet, much of the man-made CO₂ emissions cannot be captured at the source such as those originating from cars or airplanes. Additionally, capture of the already released CO₂, so called legacy CO₂, is highly desirable to reduce the overall climate impact of the CO₂ greenhouse gas.

Hence, the extraction of CO₂ from ambient air is a potential route for the mitigation of greenhouse gas emissions and associated climate change. The direct extraction of CO₂ from air via a sorbent, typically termed direct air capture (DAC), is the gold-standard technology for this objective.

A typical sorbent technology in DAC includes a porous support material functionalized with amine-containing molecules or polymers. For example, a porous silica or cellulose support material may be functionalized with amine-containing molecules or polyethyleneimine (PEI). In this type of sorbent, the amines react spontaneously with CO₂ to separate the CO₂ from the air while the porous support material provides a high surface area for the amine/air interface, ensures thar the air can flow through the sorbent, and anchors the amines in the solid sorbent, preventing their volatilization.

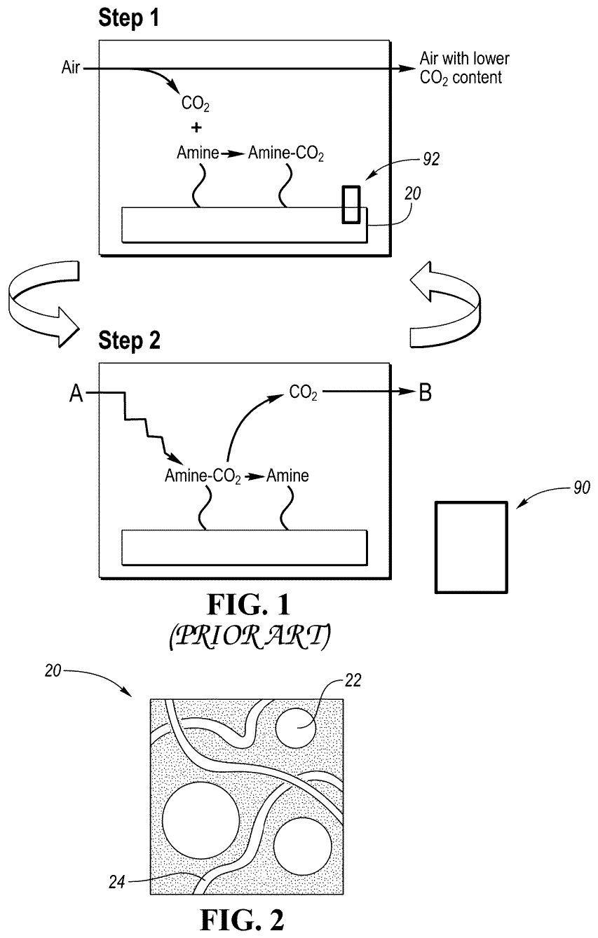

A non-limiting example DAC sorption system/process includes two steps, shown schematically in FIG. 1. As can be seen in FIG. 1, in the first stage or step 1, a sorbent 20 chosen to selectively absorb CO₂ is exposed to air until it reaches a desired saturation point. In the first step of FIG. 1, air is passed over an amine-functionalized sorbent 20, which separates CO₂ from the incoming gas stream, denoted as air. In the second stage or step 2, the sorbent is regenerated by stripping the absorbed CO₂ from the sorbent 20 and storing the captured CO₂ at high pressure and purity for later utilization or sequestration, marked as B. In the second step, the CO₂ bound to the solid sorbent 20 is detached using a change in temperature, pressure, humidity level, or other stimulus, marked as A, regenerating the sorbent to its pristine state and releasing the CO₂ for storage or utilization. The process can then be repeated. In the schematic, the line connecting “amine” to “porous support” denotes that the amines are chemically bonded to the support.

While the first stage of this process is spontaneous, as the sorbent chemistry is chosen to react favorably with CO₂, the regeneration stage requires energy input to desorb the captured CO₂. The energy may come in the form of heat, changes in external pressure, changes in humidity, changes in potential, or washing with an exchange or transfer fluid having a component with preferential affinity towards CO₂, as was described in U.S. patent application Ser. No. 18/162,326, which is hereby incorporated in its entirety by reference.

The energy cost of the DAC process, as well as the useful life of the sorbent material, are largely determined by the efficiency of the regeneration stage, making it an important design component of any DAC process. The cost of the DAC process is dependent on the amount of CO₂ which the sorbent can take up in a set amount of time as well as the energy input required to release the captured CO₂ during the regeneration stage.

Amine-functionalized solid sorbents are generally hydrophilic and absorb water alongside CO₂ with the amount and structure of absorbed water dependent on ambient conditions such as humidity and temperature, as well as the type of sorbent material used. Some water is absorbed in the bulk of the polymer at low humidity, but most of the water absorption occurs by capillary condensation in the micropores at medium-to-high humidity. The exact humidity value for condensation depends on the size of the micropores, with larger micropores more resistant to capillary condensation.

The porous sorbents used for CO₂ capture typically have a multiscale porosity schematically shown in FIG. 2. This structure may include a small number of macropores (20-200 nm diameter) and a larger number of micropores (0.5-2 nm diameter). In FIG. 2, the sorbent 20 includes macropores 22 and micropores 24. Since porosity influences the amount of CO₂ capture, it would be desirable to increase porosity to increase efficiency of CO₂ capture.

In one of more embodiments, a solid sorbent for CO₂ capture is disclosed. The sorbent may be porous. The sorbent may be a 3D structure having a solid portion and a porous portion. The porous portion may be distributed throughout the solid portion. The solid portion and the porous portion may form an internal volume of the sorbent. The sorbent may be formed into a variety of shapes, sizes, and configurations. The internal volume of the sorbent may be defined by an increased surface area compared to typical CO₂ sorbents.

The sorbent may have multiple porosity including macropores (20-200 nm diameter), micropores (0.5-2 nm diameter), and mesopores (2-20 nm). The macropores may be configured to facilitate long-range diffusion of CO₂. The micropores and mesopores may form an interpenetrating network structured to facilitate CO₂ access to the interior volume of the sorbent.

The sorbent may include one or more polymeric compounds, resins, or materials. The polymeric material may include a backbone structure with side chains facilitating chemisorption of CO₂. The side chains may be amine-functionalized. The polymeric compound may thus be amine-functionalized. A typical example of a backbone may be amine functionalized polystyrene, polyethyleneimine, polypropyleneimine, and polyallylamine. The backbone may be linear or branched. The repeating monomer unit may be homogenous or heterogenous.

The polymeric compounds may also include a rigid crosslinker molecule incorporated into the backbone, locking the backbone chains in place and preventing the chain compaction, thereby creating a permanent porosity in the material.

Traditional crosslinkers may include divinylbenzene (DVB) or diphenylmethane crosslinked by the Friedel-Crafts reaction. Formulas of DVB and diphenylmethane are shown in FIGS. 4A and 4B, respectively.

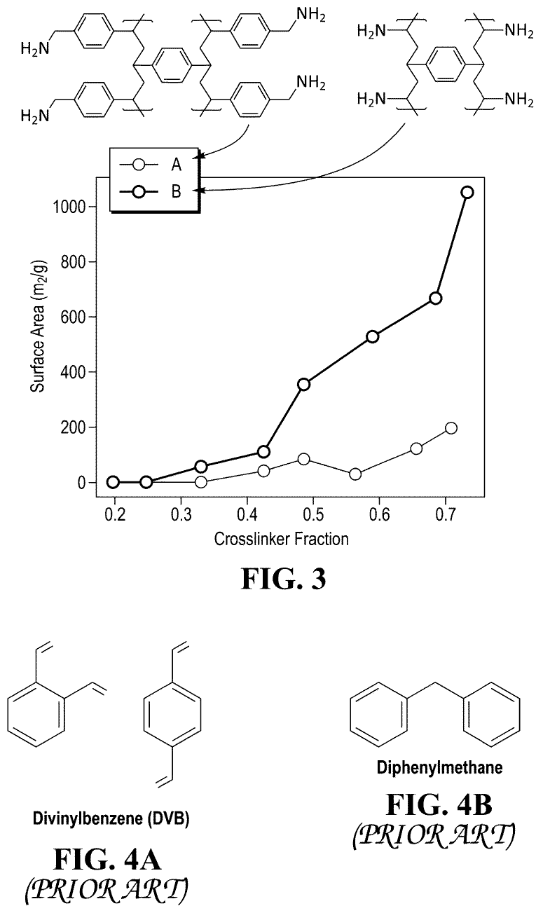

Typically, the solid portion of the sorbent is free of pores, including for example long-chained polymeric compounds. Porosity is caused, for example, by inclusion of one or more chemical groups (spacers, crosslinkers) between the chains. The chemical groups may push the chains apart, thus causing porosity in the otherwise solid material. The increased porosity may be observed as increased surface area of the sorbent internal volume. The more pores are present, the greater surface area is observed. Yet, including too many chains via a crosslinker may be counterproductive as the amount, proximity, and availability of amine groups which facilitate the capture may be then limited. To illustrate the principle, FIG. 3 is provided herein.

FIG. 3 shows schematically two examples of simulated polymer resins. Example A is a simulated crosslinked polymer resin based on amine-functionalized polystyrene crosslinked with DVB. Example B is a simulated crosslinked polymer resin based on polyallylamine crosslinked with DVB. FIG. 3 shows non-limiting examples of increasing a molar fraction of DVB crosslinker in an amine-functionalized polystyrene and polyallylamine sorbents, respectively.

Each example is shown as a line in the graph and the structure of each example is also shown with a repeating backbone monomer unit of each example. The crosslinker is represented by the ring connecting the individual chains terminating with NH₂ groups. FIG. 3 shows a plot of the polymeric material surface area in relationship to the crosslinker fraction. In the plot of FIG. 3, axis x shows the crosslinker fraction which may be defined as the ratio of crosslinker groups to the total number of monomers in the polymer chain. Monomers, that are not the crosslinker, are predominantly functionalized by NH₂ groups. The y axis shows the surface area of the internal volume of the polymer resins.

In general, crosslinkers typically increase porosity, but sacrifice amine content. As can be observed from FIG. 3, the internal surface area of polymer sorbents increases with crosslinker fraction, reflecting an increase in porosity. However, by definition, an increase in the crosslinker fraction leads to a decrease in the amine fraction, decreasing the maximum possible CO₂ binding capacity of the sorbent. Example B requires a smaller crosslinker fraction than Example A to achieve the same internal surface area and porosity, meaning that this polymer type can maintain a larger amine content and CO₂ binding capacity at a given level of porosity. Alternatively, at the same crosslinker fraction and CO₂ binding capacity, Example B has a higher porosity than Example A, meaning it allows for more robust gas permeation throughout the sorbent material. Overall, Example B is a more desirable sorbent than Example A because its internal surface area, which serves as a measure of porosity, can be higher without excessively increasing crosslinker fraction and sacrificing amine content, which is necessary for binding of CO₂. In other words, Example B requires fewer crosslinkers to achieve a set value of porosity, meaning there are more amines left in the polymeric material to bind CO₂. At a given crosslinker fraction and amine content, Example B has higher porosity than Example A, meaning it will be easier for CO₂ to permeate the material to reach the binding sites.

It was discovered that the porosity may be tuned by controlling the following: (a) the type of monomer backbone of the polymer resin, (b) the amount of the crosslinker or molar fraction of the crosslinker, and (c) the type of crosslinker. Adjusting (a), (b), (c), or their combination may thus result in a polymeric compound tailored for the sorbent application, resulting in an increased capacity of CO₂ capture. To maximize the capacity of the CO₂ capture of the sorbent, it was discovered that it is desirable to maximize the surface area of the internal volume of the sorbent at the smallest crosslinker molar fraction. The crosslinker molar fraction relates to a ratio of crosslinker groups to the total number of monomer repeating units, where the majority of non-crosslinker monomers are functionalized by NH₂ groups. Tuning of (a), (b), (c), or their combination may thus yield an optimized sorbent with (I) maximum internal surface area and (II) maximally large pore diameters with (III) a minimum molar fraction of crosslinker.

The herein-disclosed crosslinker may include, comprise, consist essentially of, or consist of at least two benzene rings. The two benzene rings may be connected. The crosslinker may include, comprise, consist essentially of, or consist of a polyphenyl such as biphenyl, terphenyl or diphenylbenzene, tetraphenyl, benzerythrene, pentaphenyl, etc., or their combination with ortho, meta, and/or para substitutions patterns. The crosslinker may thus include, comprise, consist essentially of, or consist of a benzene ring substituted with at least one phenyl group or phenyl ring. The benzene ring may be central to the substituted phenyl rings surrounding the central ring.

Alternatively, or in addition, the herein-disclosed crosslinker may include, comprise, consist essentially of, or consist of a compound with conjugated benzene rings, polycyclic aromatic hydrocarbons, arenes, cyclic unsaturated compounds, or their combination. The compound may be directly connected to the one or more side chains stemming from the backbone. The crosslinker may be free of branching, functionalization, substitution, or additional moieties stemming from the compound. The compound may be free of a vinyl, vinylidene, aliphatic, alkyl, alkane, aryl, or another linking moiety. In other words, the backbone may be free of any side chains within the backbone, thus being attached only to the amine-functionalized side chains the backbone is configured to keep apart. The compound may include nitrogen substitution or amine functionalization as is described below.

The crosslinker may include, comprise, consist essentially of, or consist of compounds such as naphthalene, anthracene, tetracene, pentacene, phenalene, phenantrene, triphenylene, pyrene, chrysene, naphtacene (tetracene), picene, perylene, etc. The crosslinker may thus include at least one compound including at least two aromatic rings. The aromatic rings may be benzene rings. At least two aromatic rings may share at least some of the adjacent atoms. The aromatic rings may be fused or condensed. The fusion may be linear or non-linear.

The crosslinker may include at least one cyclic compound with at least two unsaturated fused rings. The cyclic compound may include at least two fused rings, each ring having 4, 5, 6, 7 carbons, or their combination. The crosslinker may include pentalene, indene, azulene, heptalene, biphenylene, as-indacene, s-indacene, acenaphthylene, fluorene, fluoranthene, acephenanthrylene, aceanthrylene, pleiadene, or a combination thereof, or in a combination with at least one compound named above. Cyclic compounds with saturated rings are also contemplated.

In a non-limiting example, the cross-linker may include anthracene, terphenyl, or their combination.

The crosslinker molecule may have sufficient rigidity to maintain a relatively large distance between the side chains, NH₂ groups, end-groups of the sorbent, or a combination thereof. The distance may be constant or relatively constant. The crosslinker may be thus rigid enough to prevent compression of the polymer and elimination of the pores. The rigidity of a crosslinker molecule may be defined by considering the variation in its end-to-end distance, where the ends of the crosslinker are the chemical bonds connecting the crosslinker to the polymer backbone. A structurally rigid crosslinker may be defined as one whose end-to-end distance remains at least about 70, 75, 80, 85, 90, or 95% of its geometry at all temperatures, pressures, and chemical environments encountered or experienced by the sorbent material. The geometry may be a predetermined geometry of a desirable value, ideal relaxed geometry, or initial geometry.

The crosslinker fraction or the ratio of crosslinker groups to total number of monomers in the polymer chain of the sorbent may be about 0.05-0.6, 0.1-0.4, or 0.2-0.3. The fraction may be about, at least about, or at most about 0.05, 0.1, 0.15, 0.2, 0.25, 0.3, 0.35, 0.4, 0.45, 0.5, 0.55, or 0.6.

The polymeric material or sorbent may include about 5-60, 10-40, or 20-30 mol % crosslinker, based on the total molar number of monomers in the polymeric material or sorbent. The crosslinker molar fraction may be about, at least about, or at most about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 mol %, based on the total molar number of monomers in the polymeric material or sorbent.

The sorbent incorporating one or more crosslinker compounds disclosed herein may have internal surface area of about 5 to 1500, 10 to 500, or 15 to 100 m²/g. The internal surface area may be about or at least about 5, 10, 20, 30, 40, 50, 60, 70, 80, 90, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, or 1500 m²/g.

The disclosed crosslinker was observed to increase porosity, resulting in a sorbent with a greater number of pores, pores of a larger diameter, and increased internal surface area compared to the traditional crosslinkers named herein. Furthermore, the disclosed crosslinker was observed to reduce the crosslinker fraction required to achieve a desired porosity, resulting in a sorbent with a higher non-crosslinker fraction and thus higher amine content and CO₂ binding capacity.

Additionally, the sorbent material may be tailored to increase the amount of capturable CO₂. The amount of CO₂ that can be absorbed by a sorbent material is determined by the amine loading and amine efficiency. Amine loading may be defined as the amount of accessible primary and secondary amines in the material. Amine efficiency may be defined as the number of CO₂ molecules that can be captured per amine.

Due to various factors, amine loading may be constrained. For example, the accessible amines may be sterically blocked or otherwise prevented from chemisorption of CO₂ due to the amount of structural support in the sorbent (polymer backbone, crosslinkers) necessary to maintain the porosity of the sorbent.

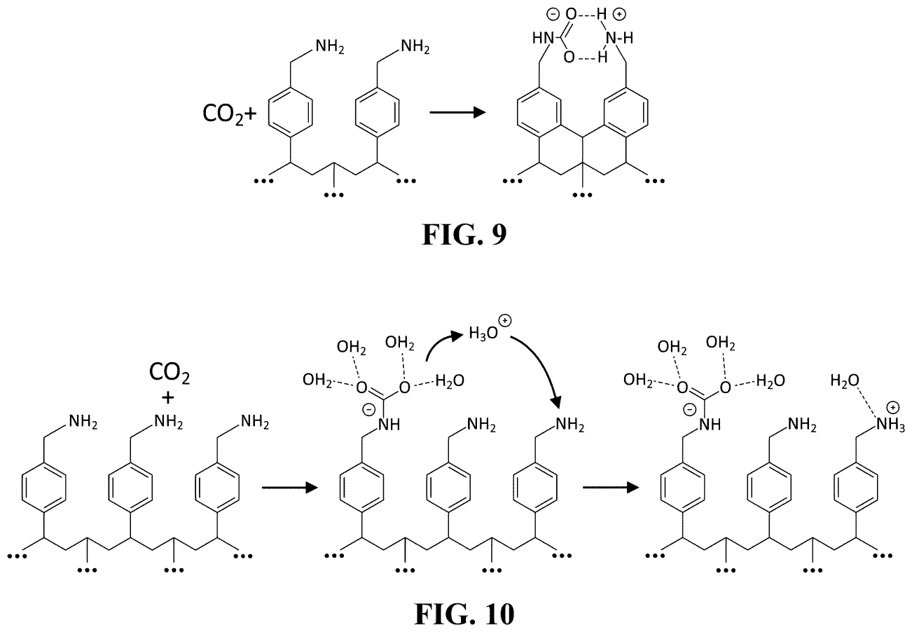

The amine efficiency is dictated by the chemical mechanism responsible for CO₂ binding and is typically limited to about 0.3 in state-of-the-art sorbents. Under dry conditions, CO₂ is absorbed by the carbamate mechanism shown in FIG. 9, where two amines are necessary to bind a single CO₂ molecule. In this case, the amine efficiency cannot exceed a value of 0.5, and is in practice limited to 0.3 by the electrostatic repulsion between the bound carbamates.

Under wet/humid conditions, CO₂ can be absorbed by a carbamic acid mechanism shown in FIG. 10, where CO₂ can be bound to a single amine, releasing a solvated hydronium ion into the sorbent. While the mechanism shown in FIG. 10 suggests the possibility of improving the amine efficiency beyond 0.5, in practice the hydronium ion binds to another amine in the material, once again leading to two amines being used to absorb a single CO₂ molecule.

It would be thus desirable to improve amine efficiency of the sorbent.

Traditionally, the crosslinker only serves structural purposes, maintaining the porosity of the sorbent, but does not contribute to the CO₂ binding chemistry.

In one or more embodiments, the crosslinker described herein is modified to include one or more proton binding sites configured to enable proton binding to the crosslinker units in the sorbent. The crosslinker may include, comprise, consist essentially of, or consist of one or more tertiary amines capable of chemisorption of CO₂ molecules. The crosslinker molecule may include, comprise, consist essentially of, or consist of at least one, more than one, two, three, four, five, six, or more proton binding sites per crosslinker molecule. The proton binding sites may include tertiary amines. The amine proton binding sites improve the amine efficiency of the sorbent under wet conditions as the added proton binding sites create additional binding sites for the hydronium ion released during the carbamic acid formation, allowing more of the primary and secondary amines in the material to bind CO₂.

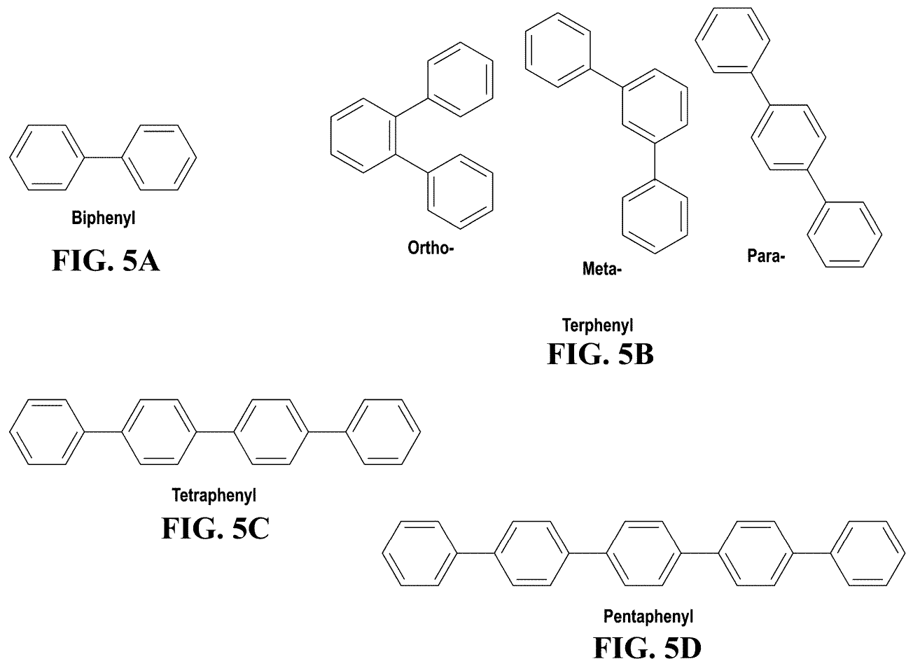

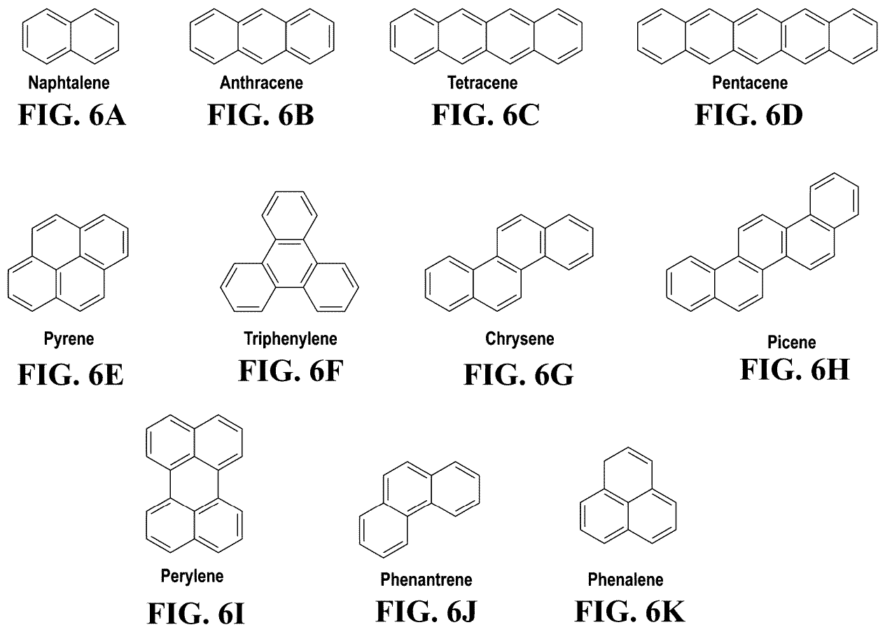

The crosslinker may include, comprise, consist essentially of, or consist of one or more pyridine rings, pyrazine rings, of their combination. The rings may be fused, linear, non-linear, include substitutions, or their combination. In a non-limiting example, the crosslinker may include pyrazine, phenazine, pyridazine, pyrimidine, and/or other tertiary-amine-containing ring. Non-limiting example compounds may be the compounds depicted in FIGS. 5A-5D and 6A-6K with at least one tertiary amine incorporated in at least one of the rings. Each ring may include one or two tertiary amines. At least some of the rings may include one or two tertiary amines.

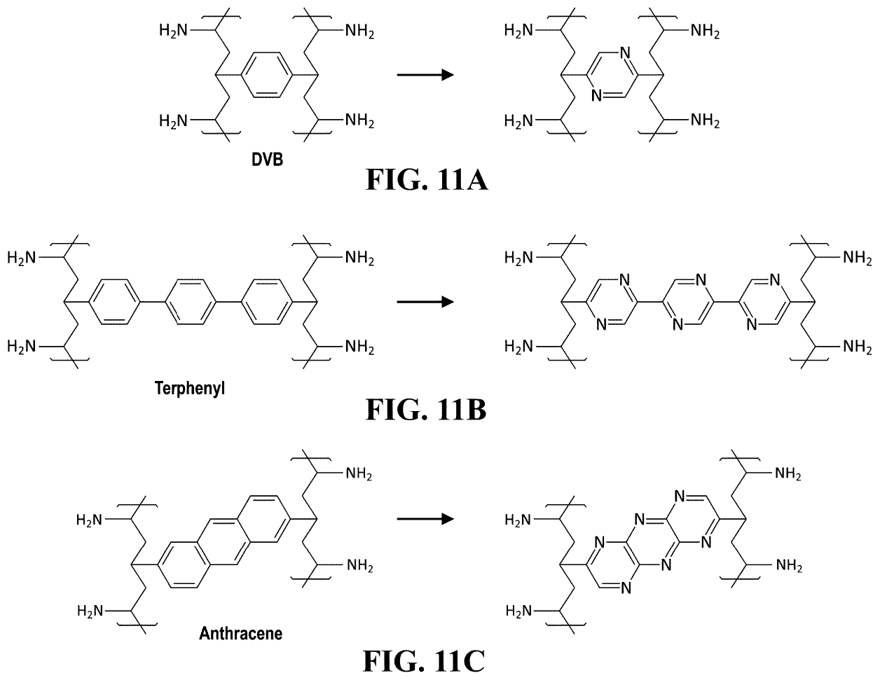

A non-limiting example crosslinker disclosed herein may include divinylpyrazine, shown in FIG. 11A in comparison with traditional DVB. Additional non-limiting examples are shown in FIGS. 11B and 11C.

As a result, amine efficiency of the sorbent may be greater than 0.3, 0.4, or 0.5. The sorbent may thus include a polymeric material having amine-functionalized side chains and amine-functionalized backbone structured to maintain a distance between the side chains.

It was also discovered that the amine should ideally be a tertiary amine as opposed to primary or secondary amines to maintain rigidity sufficient to maintain distance between the side chains resulting in desired porosity. Inclusion of at least some secondary amines in the proton binding sites is contemplated, for example in combination with tertiary amines.

Primary and secondary amine (to a lesser degree) incorporation in the crosslinker compound was shown to result in folding and collapse of the porous structure of the sorbent material. Primary amines do not provide structural support and are not depicted.

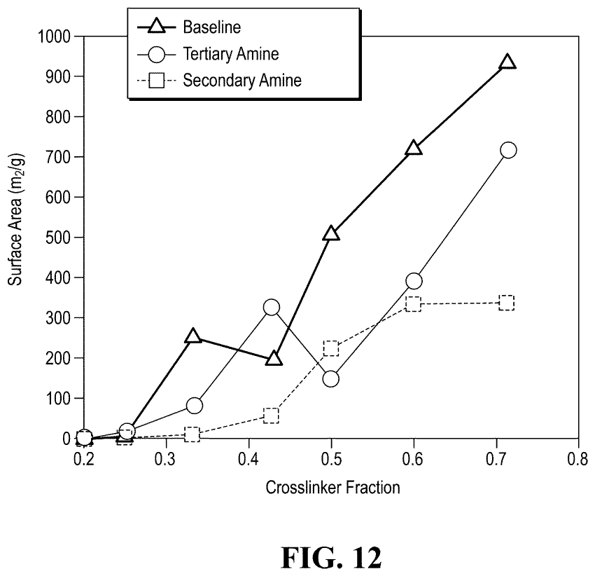

FIG. 12 depicts the internal surface area of three systems: a baseline system that does not have amines in the crosslinker, and two systems containing secondary and tertiary amines in the crosslinker. The data was derived from an atomistically simulated representative structure of the amorphous polymer resins. The internal surface area was used as a measure of the porosity of the sorbent. While both tertiary and secondary amines decreased the porosity compared to the baseline case, the secondary amine scenario resulted in a larger loss of porosity. This data illustrates a tradeoff between the improved CO₂ binding capacity (amine content) of the sorbent, and its porosity.

To mitigate the loss of porosity with amine incorporation into the crosslinker, some crosslinker molecules may remain free of proton binding sites while other crosslinker molecules may include at least one tertiary amine. The sorbent may thus include a mixture of crosslinkers disclosed herein, a first portion of crosslinkers configured for structural purposes such as added surface area and porosity, a second portion of crosslinkers configured to improve amine efficiency.

A method of forming a sorbent for DAC of CO₂ capture is disclosed herein. The method may include forming a porous sorbent including a functional group configured to capture or bind CO₂ from air and immobilizing the functional group on a support material which includes pores. The method may include polymerization, crosslinking of base components using one or more crosslinkers disclosed herein, or both to form a porous support material.

A method of using the herein-disclosed sorbent is disclosed herein. The method may include providing the sorbent in a DAC system. The method may include sorbing CO₂ within the sorbent until a predetermined CO₂ saturation point, value, or range. The method may include regenerating the sorbent by using an exchange fluid with affinity to CO₂, thermally, or otherwise.

The sorbent disclosed herein may be part of a system structured to sequester CO₂ from dilute sources. The system may be a DAC system. The system is arranged to capture CO₂ from air, atmosphere. The capture may be direct capture. The CO₂ may be anthropogenic CO₂, legacy CO₂, naturally produced CO₂, CO₂ from various sources such as decomposition CO₂, ocean release CO₂, respiration CO₂, industrial sources CO₂, deforestation CO₂, fossil fuel burning CO₂, transportation CO₂, fuel combustion CO₂, exhaust CO₂, the like, or their combination.

The system includes several components which cooperate mechanically, physically, chemically, fluidly, or a combination thereof. The system may include one more compartments housing the porous sorbent, one or more mechanisms configured to regenerate the sorbent, one or more apparati for storage of the captured CO₂, one or more components for release of the outgoing air having a lower concentration of CO₂ than the incoming air, the like, or a combination thereof. The compartment may be a tank, vessel, container, canister, capsule, tub, chamber, cistern, flask, receptacle, or the like. The container may be a closed, enclosable, openable, scalable, and/or resealable container.

The compartments may include one or more air inputs structured as resealable or enclosable openings, one or more conduits connecting one or more portions of the system and arranged to lead one or more fluids between various portions of the system. The fluids may be air, exchange liquid(s), electrolyte(s), etc. The compartment may include one or more conduits to lead CO₂-free air from the compartment.

The system may utilize the solid porous sorbent in combination with a liquid exchange of transfer fluid having a chemical with preferential affinity for CO₂, configured to regenerate the sorbent after CO₂ is bound to the sorbent to a predetermined saturation point. The regeneration may be realized by mediated transport of CO₂ from the sorbent by removing, desorbing, stripping, or displacing CO₂ absorbed onto the sorbent, and binding the CO₂. Alternatively, the system may use heat, changes in external pressure, changes in RH to regenerate the porous sorbent. The system may thus include a heat source, pressure regulator(s), humidity control system, or the like.

The system may further include one or more controllers, sensors, or both, receiving or providing inputs and outputs to trigger binding of CO₂, release of CO₂ from the sorbent, regeneration of the sorbent, or a combination thereof. The controller(s) may thus monitor, adjust, initiate, terminate, or contribute to binding and/or release of the sorbent, for example by controlling, adjusting, monitoring RH of the system, subsystem, or cell which the sorbent is present in. Alternatively, controlled flooding may be secured by the structural features of the sorbent disclosed herein and may not need a controller's assistance. Non-limiting examples of a controller 90 and sensor 92 are schematically depicted in the system shown in FIG. 1. The placement and configuration is just schematical and may differ from that depicted in FIG. 1.

### Example 1, 2, and Comparative Example A

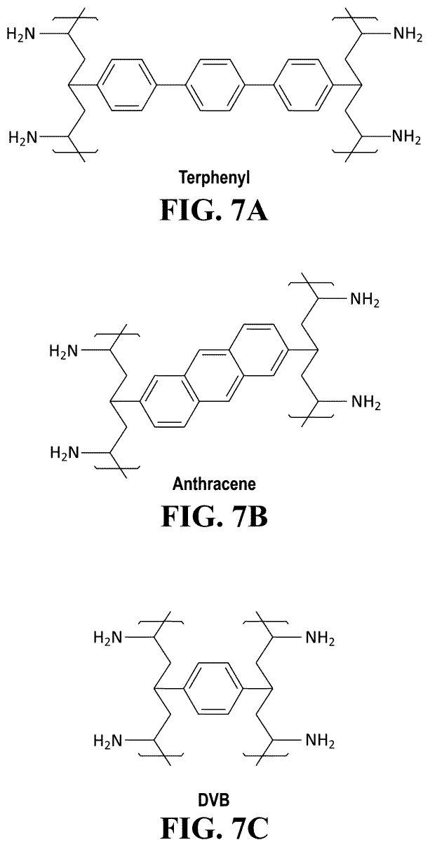

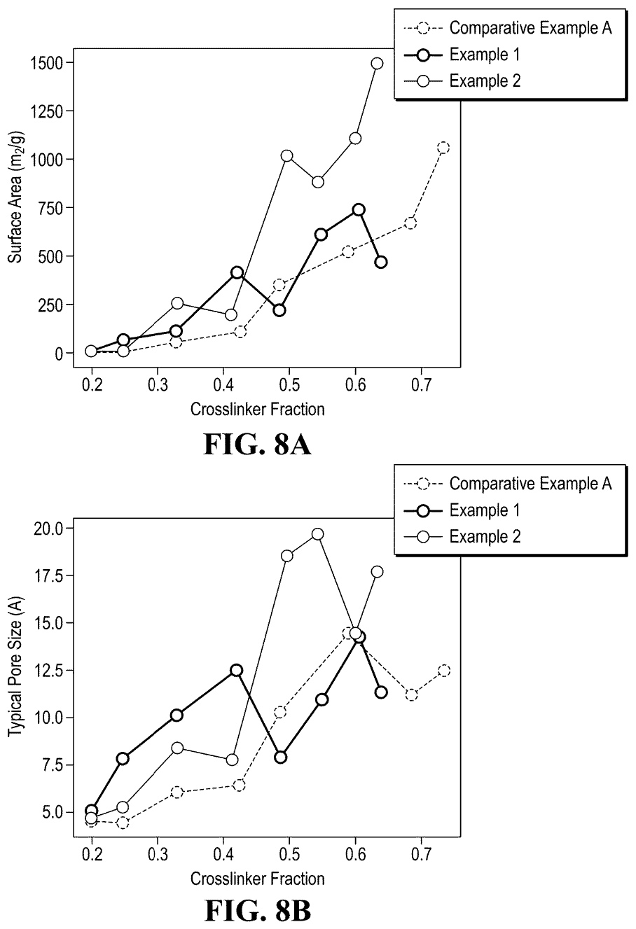

Simulated crosslinked polymer resins were prepared using polyallylamine crosslinked with DVB (Comparative Example A), terphenyl (Example 1), and anthracene (Example 2). The repeating monomer units with the rigid crosslinkers are shown in FIGS. 7A-7C. Two plots were prepared showing the increase in surface area (FIG. 8A) and average or typical pore size (FIG. 8B) depending on the crosslinker fraction of each Example and Comparative Example.

As can be observed from FIG. 8A, an average pore size increased sharply for Example 1 at a low crosslinker fraction of about 0.25. While the average pore size with Comparative Example at 0.25 crosslinker fraction was below 5 A, Example 1 reached 7.5 A. At 0.3 crosslinker fraction, Example 1 had average pore size of about 10 A, Example 2 about 8 A, while Comparative Example A about 6 A. A dramatic increase of average pore size was observed from Example 2 between 0.4 and 0.5 crosslinker fraction. In conclusion, a greater average pore size is achievable with a relatively low molar crosslinker fraction for Examples 1 and 2 in comparison to Comparative Example A.

As can be seen in FIG. 8B, a greater surface area of the resin may be obtained at a lower crosslinker fraction for both Examples 1 and 2 in comparison to Comparative Example A. Specifically, at about 0.325 crosslinker fraction, Examples 1 and 2 had visibly greater surface area than Comparative Example A. Example 2 surface area increased dramatically between 0.42 and 0.6 crosslinker fraction, reaching beyond 1500 m²/g while comparative Example A's maximum was at 1000 m²/g.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A sorbent for direct air capture of CO₂ comprising:
a porous amine-functionalized polymeric material including a backbone and a plurality of side chains having amine groups branching from the backbone, the backbone including a rigid crosslinker having crosslinker groups,
a ratio of the crosslinker groups to a total number of monomer repeating units in the polymeric material is about 0.1 to 0.4 such that the polymeric material's internal surface area is about 10 to 500 m²/g.

2. The sorbent of claim 1, wherein an average micropore size of the sorbent is about 5 to 20 A.

3. The sorbent of claim 1, wherein the crosslinker retains an end-to-end distance of at least about 70% of its predetermined molecular geometry.

4. The sorbent of claim 1, wherein the polymeric material is polyallylamine.

5. The sorbent of claim 1, wherein the polymeric material is polystyrene.

6. The sorbent of claim 1, wherein the crosslinker includes a conjugated benzene.

7. The sorbent of claim 6, wherein the conjugated benzene includes anthracene.

8. The sorbent of claim 1, wherein the crosslinker includes a polyphenyl compound directly bound to a side chain of the polymeric sorbent.

9. A sorbent for direct air capture of CO₂ comprising:
a porous amine-functionalized polymeric material having an internal surface area of about 10 to 1500 m²/g at crosslinker fraction of about 20 to 60 mol %, based on a total molar number of monomers in the polymeric sorbent,
the crosslinker including at least two benzene rings.

10. The sorbent of claim 9, wherein the crosslinker is a rigid crosslinker which maintains an end-to-end distance of a least 70% of predetermined molecular geometry.

11. The sorbent of claim 9, wherein an average micropore size of the sorbent is about 5 to 20 A.

12. The sorbent of claim 9, wherein the crosslinker includes a conjugated benzene compound.

13. The sorbent of claim 9, wherein the crosslinker includes anthracene.

14. The sorbent of claim 9, wherein the crosslinker includes a polyphenyl directly bound to a side chain of the polymeric sorbent.

15. A system for direct air capture of CO₂, the system comprising:
a compartment housing a porous amine-functionalized polymeric sorbent including a rigid crosslinker configured to maintain a distance between amine groups of the sorbent, the crosslinker being included in an amount of about 20 to 60 mol %, based on a total molar number of monomers in the polymeric sorbent, and having at least one benzene ring;
a first conduit structured to bring air into the compartment; and
a second conduit structured to lead CO₂-free air from the compartment.

16. The system of claim 15, wherein the crosslinker is a rigid crosslinker which maintains an end-to-end distance of a least 70% of its predetermined molecular geometry.

17. The system of claim 15, wherein an average micropore size of the sorbent is about 5 to 20 A.

18. The system of claim 15, wherein the crosslinker includes a conjugated benzene.

19. The system of claim 15, wherein the crosslinker includes a polyphenyl directly bound to a side chain of the polymeric sorbent.

20. The system of claim 15, wherein the crosslinker includes anthracene.
